(19) United States
(12) Patent Application Publication
(10) Pub. No.: US 2016/0072917 A1
(43) Pub. Date: Mar. 10, 2016

(54) DISTRIBUTED COMPUTING METHOD AND SYSTEM

(71) Applicants: HONG FU JIN PRECISION INDUSTRY (WUHAN) CO., LTD., Wuhan (CN); HON HAI PRECISION INDUSTRY CO., LTD., New Taipei (TW)

(72) Inventors: KAI-LONG HUANG, Wuhan (CN); CHUN-SHENG CHEN, New Taipei (TW)

(21) Appl. No.: 14/525,901

(22) Filed: Oct. 28, 2014

(30) Foreign Application Priority Data
Sep. 5, 2014 (CN) 201410450906.3

(51) Int. Cl. H04L 29/08

(52) U.S. Cl. CPC H04L 67/32; H04L 67/10

(57) ABSTRACT

A distributed computing system is disclosed. The system includes a host computer and a plurality of mobile computing devices in communication with the host computer via a communication network. The host computer splits a computing task into a multiple independent calculations and assigns the independent calculations to the mobile computing devices. The mobile computing devices execute the independent calculations and transmit results of the independent calculations to the host computer. The host computer obtains an end result of the computing task by combining the results of the plurality of independent calculations. A distributed computing method is also disclosed.

### CROSS-REFERENCE TO RELATED APPLICATIONS

This application claims priority to Chinese Patent Application No. 201410450906.3 filed on Sep. 5, 2014, the contents of which are hereby incorporated by reference.

### FIELD

The disclosure generally relates to computing methods and systems, and more particularly relates to distributed computing methods and systems utilizing computing power of mobile computing devices.

### BACKGROUND

Mobile computing devices such smart phones, PDAs and tablet PCs are getting more and more powerful. However, the duty cycle of such devices is typically quite small, focusing on brief, ad-hoc, on-demand activities. Furthermore these devices have become ubiquitous, and via “always on” connections will be permanently accessible to a global network of other devices. There will thus be an explosive growth of well-connected “unused” CPU cycles sitting in people's back pockets.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the views.

FIG. 1 is a block diagram of an embodiment of a distributed computing system.

FIG. 2 is a flowchart of an embodiment of a distributed computing method.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein. It should be noted that references to “an” or “one” embodiment in this disclosure are not necessarily to the same embodiment, and such references can mean “at least one.”

The term “comprising” means “including, but not necessarily limited to”; it specifically indicates open-ended inclusion or membership in a so-described combination, group, series and the like.

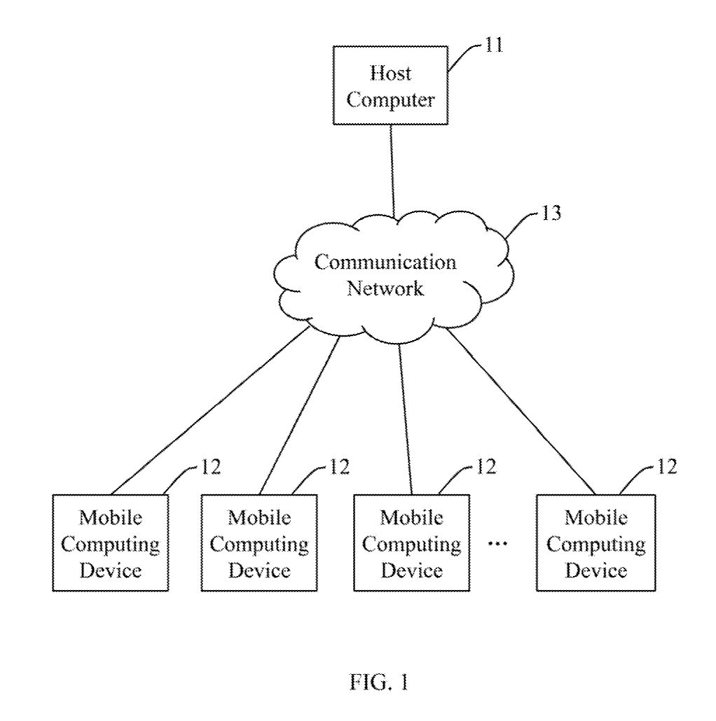

FIG. 1 illustrates a block diagram of an embodiment of a distributed computing system. The computing system can include a host computer 11 and a plurality of mobile computing devices 12. The mobile computing devices 12 can be, but not limited to be, smartphones, tablets PCs, PDAs, or other handheld devices.

The host computer 11 can establish a communication connection with the mobile computing devices 12 via a communication network 13. The communication network 13 can be, but not limited to be, an Ethernet LAN, a WIFI network, a cellular data network, or other IP network.

The host computer 11 can communicate with the mobile computing devices 12 via the communication network 13. Each of the mobile computing devices 12 can send information of its computing capability to the host computer 11 via the communication network 13. The host computer 11 can count the number of the mobile computing devices 12 which are in communication with the host computer 11. The computing capability of the mobile computing device 12 can refer to the hardware level of the mobile computing device 12, such as the processing capacity of a CPU, the storage capacity of a memory, a bandwidth of data transmission.

The host computer 11 can split a computing task into a plurality of independent calculations according to the number of the mobile computing devices 12 and the computing capabilities of the mobile computing devices 12. Then the host computer 11 can assign the independent calculations to the mobile computing devices 12 via the communication network 13. The host computer 11 can determine a number of the independent calculations which are assigned to a mobile computing device 12 based on the computing capability of the mobile computing device 12. For example, if the computing capability of a mobile computing device 12 is small, the host computer 11 can assign a small number of the independent calculations to the mobile computing device 12; if the computing capability of a mobile computing device 12 is great, the host computer 11 can assign a great number of the independent calculations to the mobile computing device 12.

The host computer 11 can establish an unassigned task pool and an assigned task pool in a local storage device of the host computer 11. The host computer 11 can place the unassigned independent calculations in the unassigned task pool and place the assigned independent calculations in the assigned task pool.

When the mobile computing devices 12 receive the independent calculations from the host computer 11, the mobile computing devices 12 can execute the independent calculations and transmit the results of the independent calculations to the host computer 11 via the communication network 13.

When the host computer 11 receives the results the independent calculations from the mobile computing devices 12, the host computer 11 can obtain an end result of the computing task by combining the results of the independent calculations.

In some embodiments, the host computer 11 can associate a deadline with each of the independent calculations. When the host computer 11 does not receive a result of an independent calculation from a mobile computing device 12 by a deadline of the independent calculation, the host computer 11 can send a revoking message to the mobile computing device 12 to revoke the independent calculation and reassign the independent calculation to another mobile computing device 12.

When a mobile computing device 12 intends to quit the distributed computing system or suspends providing computing power to the host computer 11, the mobile computing device 12 can send a rejecting message to the host computer 11. When the host computer 12 receives the rejecting message from the mobile computing device 12, the host computer 12 can disconnect from the mobile computing device 12.

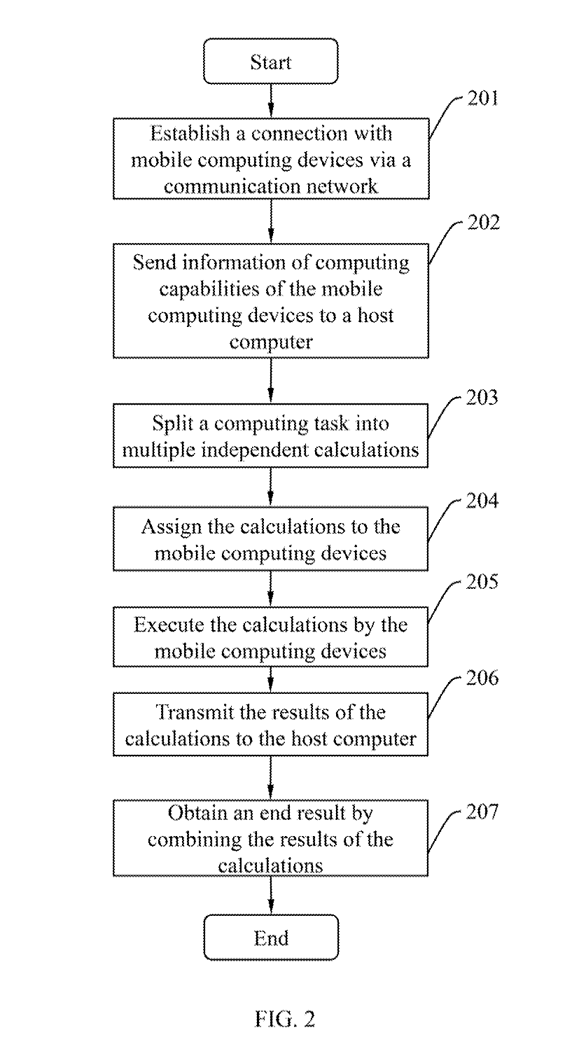

Referring to FIG. 2, a flowchart of a distributed computing method is presented in accordance with an example embodiment which is being thus illustrated. The example method is provided by way of example, as there are a variety of ways to carry out the method. The method described below can be carried out using the configurations illustrated in FIG. 1, for example, and various elements of these figures are referenced in explaining example method. Each block shown in FIG. 2 represents one or more processes, methods or subroutines, carried out in the exemplary method. Additionally, the illustrated order of blocks is by example only and the order of the blocks can change according to the present disclosure. The exemplary method can begin at block 201.

At block 201, a host computer 11 establishes a communication connection with a plurality of mobile computing devices 12 via a communication network 13. The communication network 13 can be, but not limited to be, an Ethernet LAN, a WIFI network, a cellular data network, or other IP network.

At block 202, each of the mobile computing devices 12 sends information of its computing capability to the host computer 11 via the communication network 13. The computing capability of the mobile computing device 12 can refer to the hardware level of the mobile computing device 12, such as the processing capacity of a CPU, the storage capacity of a memory, a bandwidth of data transmission.

At block 203, the host computer 11 splits a computing task into a plurality of independent calculations according to the number of the mobile computing devices 12 and the computing capabilities of the mobile computing devices 12.

At block 204, the host computer 11 assigns the independent calculations to the mobile computing devices 12 via the communication network 13. In some embodiments, the host computer 11 determines a number of the independent calculations which are assigned to a mobile computing device 12 based on the computing capability of the mobile computing device 12.

At block 205, when the mobile computing devices 12 receive the independent calculations from the host computer 11, the mobile computing devices 12 execute the independent calculations.

At block 206, the mobile computing devices 12 transmit the results of the independent calculations to the host computer 11 via the communication network 13.

At block 207, when the host computer 11 receives the results the independent calculations from the mobile computing devices 12, the host computer 11 obtains an end result of the computing task by combining the results of the independent calculations.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A distributed computing method comprising:
establishing a communication connection between a host computer and a plurality of mobile computing devices via a communication network;
splitting a computing task into a plurality of independent calculations by the host computer;
assigning the plurality of independent calculations to the plurality of mobile computing devices via the communication network by the host computer;
executing the plurality of independent calculations by the plurality of mobile computing devices;
transmitting results of the plurality of independent calculations to the host computer via the communication network by the plurality of mobile computing devices; and
obtaining an end result of the computing task by combining the results of the plurality of independent calculations by the host computer.

2. The distributed computing method of claim 1, further comprising:
sending information of computing capabilities of the plurality of mobile computing devices to the host computer via the communication network; and
determining a number of independent calculations which are assigned to a mobile computing device based on the computing capability of the mobile computing device.

3. The distributed computing method of claim 2, further comprising:
counting a number of the plurality of mobile computing devices which are in communication with the host computer; and
splitting the computing task into the plurality of independent calculations according to the number of the plurality of mobile computing devices and the computing capabilities of the plurality of mobile computing devices.

4. The distributed computing method of claim 1, further comprising:
establishing an unassigned task pool and an assigned task pool in a local storage device of the host computer;
placing unassigned independent calculations of the plurality of independent calculations in the unassigned task pool; and
placing assigned independent calculations the plurality of independent calculations in the assigned task pool.

5. The distributed computing method of claim 1, further comprising:
associating a deadline with each of the plurality of independent calculations by the host computer;
when the host computer does not receive a result of one of the plurality of independent calculations from one of the plurality of mobile computing devices by a deadline of the one of the plurality of independent calculations, reassigning the one of the plurality of independent calculations to another mobile computing device by the host computer.

6. The distributed computing method of claim 5, further comprising:
when the host computer does not receive a result of one of the plurality of independent calculations from one of the plurality of mobile computing devices by a deadline of the one of the plurality of independent calculations, sending a revoking message to the one of the plurality of mobile computing devices to revoke the independent calculation by the host computer.

7. The distributed computing method of claim 1, further comprising:
sending a rejecting message to the host computer by one of the plurality of mobile computing devices; and
disconnecting from the one of the plurality of mobile computing devices by the host computer.

8. A distributed computing system comprising:
a host computer; and
a plurality of mobile computing devices in communication with the host computer via a communication network;
wherein the host computer is configured to split a computing task into a plurality of independent calculations and assign the plurality of independent calculations to the plurality of mobile computing devices via the communication network; the plurality of mobile computing devices are configured to execute the plurality of independent calculations and transmit results of the plurality of independent calculations to the host computer via the communication network; and the host computer is configured to obtain an end result of the computing task by combining the results of the plurality of independent calculations.

9. The distributed computing system of claim 8, wherein the plurality of mobile computing devices are further configured to send information of computing capabilities of the plurality of mobile computing devices to the host computer via the communication network; and the host computer is further configured to determine a number of independent calculations which are assigned to a mobile computing device based on the computing capability of the mobile computing device.

10. The distributed computing system of claim 9, wherein the host computer is further configured to count a number of the plurality of mobile computing devices which are in communication with the host computer and split the computing task into the plurality of independent calculations according to the number of the plurality of mobile computing devices and the computing capabilities of the plurality of mobile computing devices.

11. The distributed computing system of claim 8, wherein the host computer is further configured to establish an unassigned task pool and an assigned task pool in a local storage device of the host computer, place unassigned independent calculations of the plurality of independent calculations in the unassigned task pool, and place assigned independent calculations the plurality of independent calculations in the assigned task pool.

12. The distributed computing system of claim 8, wherein the host computer is further configured to associate a deadline with each of the plurality of independent calculations; when the host computer does not receive a result of one of the plurality of independent calculations from one of the plurality of mobile computing devices by a deadline of the one of the plurality of independent calculations, the host computer is configured to reassign the one of the plurality of independent calculations to another mobile computing device.

13. The distributed computing system of claim 12, wherein when the host computer does not receive a result of one of the plurality of independent calculations from one of the plurality of mobile computing devices by a deadline of the one of the plurality of independent calculations, the host computer is configured to send a revoking message to the one of the plurality of mobile computing devices to revoke the independent calculation.

14. The distributed computing system of claim 8, wherein when one of the plurality of mobile computing devices sends a rejecting message to the host computer, the host computer is configured to disconnect from the one of the plurality of mobile computing devices.
